(19) United States
(12) Patent Application Publication
(10) Pub. No.: US 2020/0147670 A1
(43) Pub. Date: May 14, 2020

(54) MANUFACTURING METHOD AND STRUCTURE OF WHEEL RIM

(71) Applicant: ALEX GLOBAL TECHNOLOGY, INC., TAINAN CITY (TW)

(72) Inventor: WEI-CHIN CHEN, TAINAN CITY (TW)

(21) Appl. No.: 16/188,701

(22) Filed: Nov. 13, 2018

(51) Int. Cl. B21D 53/30; B60B 3/02; B21K 1/38

(52) U.S. Cl. CPC B21D 53/30; B60B 3/001; B21K 1/38; B60B 3/02

(57) ABSTRACT

The invention relates to a manufacturing method and a structure of a wheel rim. The manufacturing method mainly comprises the steps of forming a rim body made of a carbon fiber material in a cavity of a molding die; forming a rim assembly by extruding a metal material and assembling the rim assembly to the rim body; and forming a rim coating by tightly encapsulating a carbon fiber material on a surface of the rim body assembled with the rim assembly.

### BACKGROUND OF THE INVENTION

### 1. Field of the Invention

The present invention relates to a manufacturing method and a structure of a wheel rim which can improve the manufacturing efficiency, yield, safety and durability of a wheel and reduce the weight and manufacturing cost of the wheel.

### 2. Description of Related Art

Generally, the existing carbon fiber wheel rim is mainly inflated by an annular airbag, and then an outer surface of the airbag is sequentially coated with plural layers of carbon fiber fabrics. However, due to the soft texture of the airbag, the procedure for attaching the carbon fiber fabrics to the surface of the airbag is quite complicated and time consuming. Especially, the carbon fiber fabrics are difficult to flatly paste on the soft airbag, resulting in high defect rates in existing carbon fiber wheel rims.

After the plural layers of carbon fiber fabrics are stacked to form a rim shape, the carbon fibers must be hardened by a process such as heating which results in a lack of ductility of the carbon fibers. In such a case, as the carbon fiber wheel rims of the bicycle is driven to rotate on an uneven road and is subjected to shocks, e.g. vibration, the carbon fiber wheel rim cannot withstand the impact force, and is easily broken or damaged. Furthermore, the upper ends of the two lateral walls of the abovementioned carbon fiber wheel rim cannot be formed with convex ribs for engaging with tire lips, and the flanges can be formed only by thickening the stack of carbon fiber fabrics. As a result, the bonding of the existing carbon fiber wheel rim and the tire is not stable enough, and the tire is easily detached from the carbon fiber wheel rim. When the carbon fiber wheel rim is used as a tubeless wheel rim, it may cause air leakage due to poor adhesion, which affects the safety of bicycle riders.

### SUMMARY OF THE INVENTION

In view of the above-mentioned problems, the object of the present invention is to provide a manufacturing method and a structure of a wheel rim which can improve the manufacturing efficiency, yield, safety and durability of a wheel and reduce the weight and manufacturing cost of the wheel.

Disclosed herein is a manufacturing method and a structure of a wheel rim. The manufacturing method of a wheel rim mainly comprises the steps of forming a rim body made of a carbon fiber material in a cavity of a molding die; forming a rim assembly by extruding a metal material and assembling the rim assembly to the rim body; and forming a rim coating by tightly encapsulating a carbon fiber material on a surface of the rim body assembled with the rim assembly.

Accordingly, the present invention improves the manufacturing efficiency and yield of a wheel, achieves the effect of lightening the wheel weight, and reduces the manufacturing cost of the wheel. In addition, the present invention prevents the tire from leaking or falling off by firmly engaging an engaging rib at an upper end of the metal rim assembly with tire lips of a tire. Due to the ductility of the rim assembly made of the metal material and the rigidity of the rim body made of the carbon fiber material, the present invention can withstand the impact of road shocks so that the wheel is not easily broken or damaged, and the safety and durability of the wheel can be improved.

### BRIEF DESCRIPTION OF THE DRAWINGS

FIG. 1 is a flow chart showing a manufacturing method of a composite wheel according to the present invention;

FIG. 2 is a cross-sectional diagram showing a composite wheel according to the present invention;

FIG. 3 is an exploded diagram showing a rim body and a rim assembly according to the present invention;

FIG. 4 is a schematic diagram showing a rim body assembled to a rim assembly according to the present invention;

FIG. 5 is a schematic diagram showing a first embodiment for a composite wheel in assembly according to the present invention;

FIG. 6 is a schematic diagram showing a second embodiment for a composite wheel in assembly according to the present invention.

### DETAILED DESCRIPTION OF THE PREFERRED EMBODIMENT

Hereinafter, an exemplary embodiment of the present invention will be described in detail with reference to the accompanying drawings.

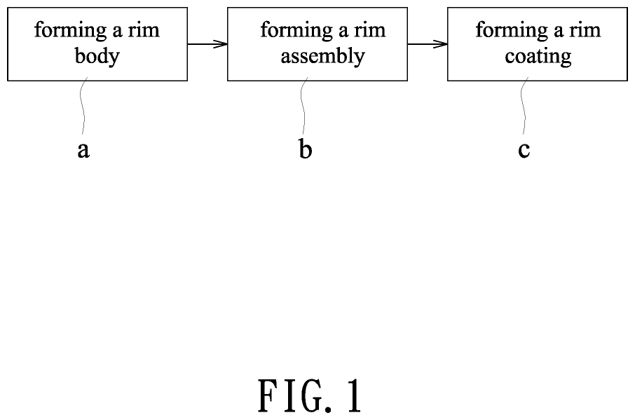

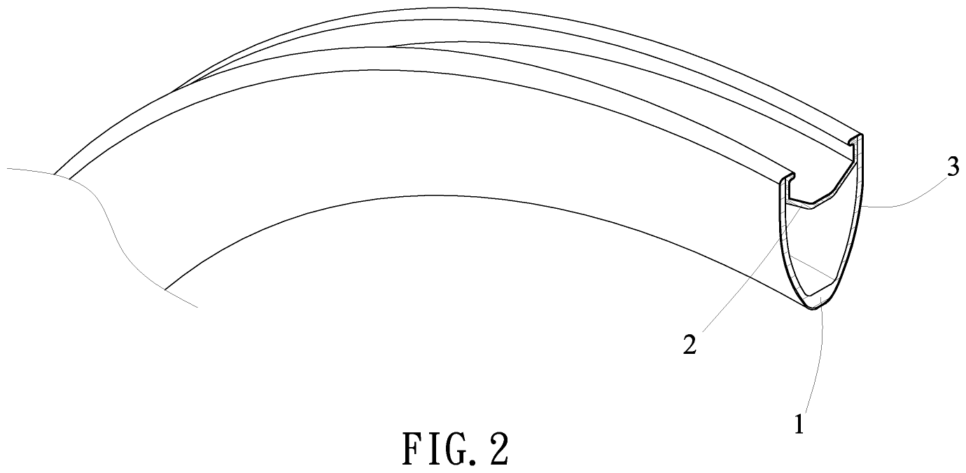

As showed in FIG. 1 and FIG. 2, a manufacturing method and a structure of a wheel rim according to the present invention are disclosed herein. The manufacturing method mainly comprises the steps of (a) forming a rim body, (b) forming a rim assembly, and (c) forming a rim coating.

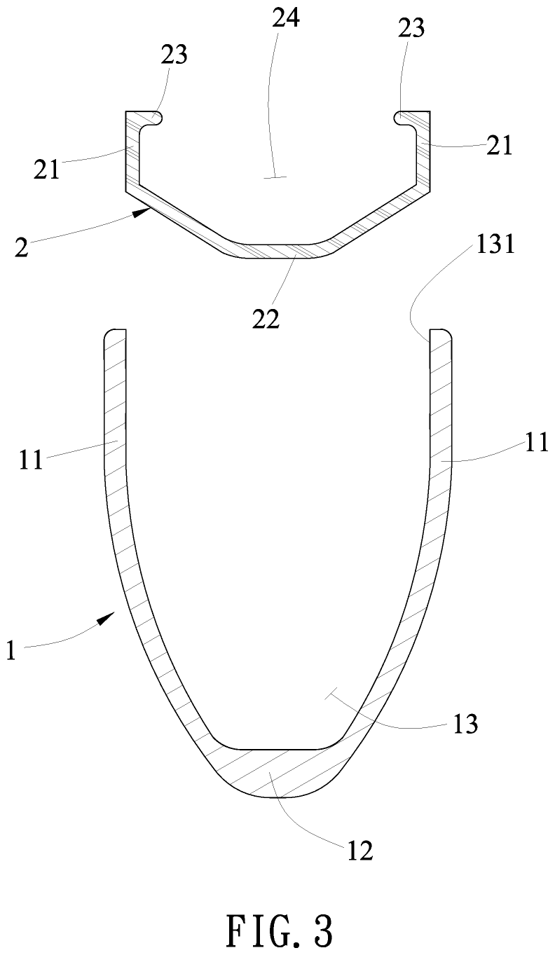

The step (a) comprises preparing a molding die having a cavity and coating plural layers of carbon fiber material in the cavity for hardening and shaping by heating to form a rim body (1). Preferably, the carbon fiber material is a carbon fiber fabric. Referring to FIG. 3, the rim body (1) has two lateral walls (11) opposite to each other, a bottom wall (12) for connecting lower ends of the two lateral walls (11), and an accommodating space (13) defined by the two lateral walls (11) and the bottom wall (12). The accommodating space (13) has an opening (131) formed at an upper end of the rim body (1).

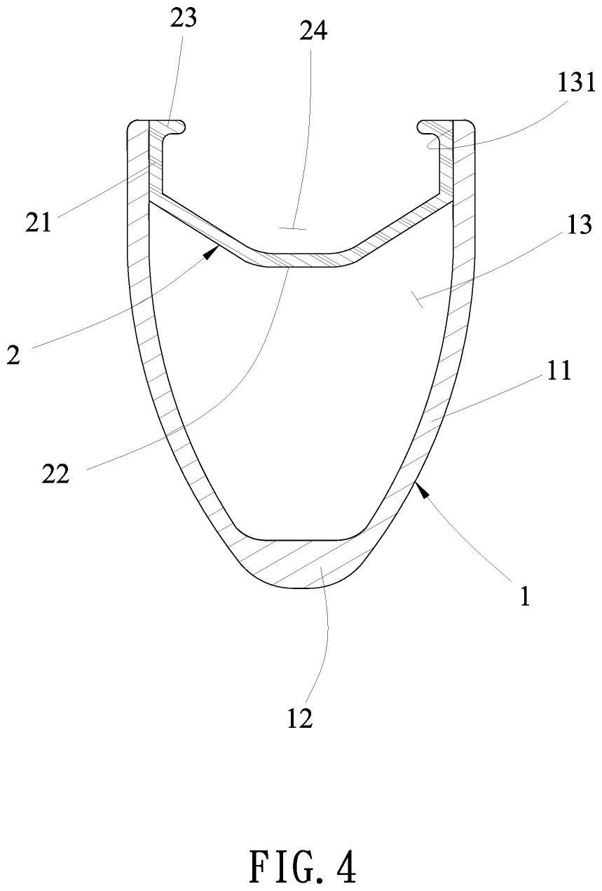

The step (b) comprises extruding a metal material to shape as a long strip and bending the long strip by a reeling machine so as to form a rim assembly (2). Preferably, the metal material is aluminum alloy. The rim assembly (2) made of the metal material has two connecting parts (21) opposite to each other, a basal part (22) for connecting lower ends of the two connecting parts (21), and two engaging ribs (23) respectively bending inwardly at upper ends of the two connecting parts (21). Referring to FIG. 4, the rim assembly (2) is assembled in the accommodating space (13) of the rim body (1). The two connecting parts (21) of the rim assembly (2) respectively contact the two lateral walls (11) of the rim body (1) for positioning, and the two engaging ribs (23) of the rim assembly (2) are located at the opening (131) at an upper end of the accommodating space (13). The rim assembly (2) further comprises an assembling space (24) defined by the two engaging ribs (23), the two connecting parts (21) and the basal part (22).

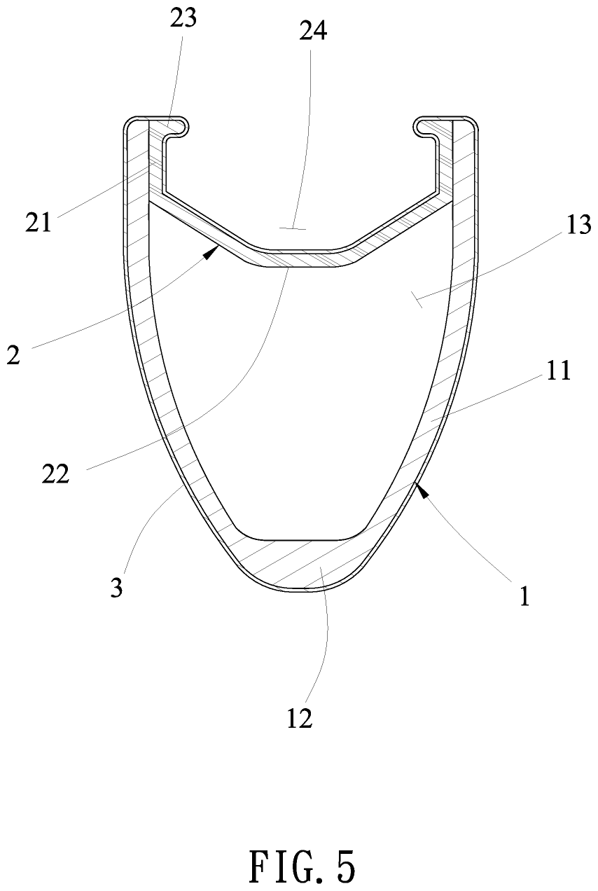

Referring to FIG. 5, the step (c) comprises tightly encapsulating at least one carbon fiber material (preferably a carbon fiber fabric) on a surface of the rim body (1) assembled with the rim assembly (2) for hardening and shaping by heating so as to form a rim coating (3).

Accordingly, the end product of a wheel rim is manufactured by the above-mentioned steps. Specifically, it comprises a rim body (1) made of a carbon fiber material and having two lateral walls (11) opposite to each other, a bottom wall (12) for connecting lower ends of the two lateral walls (11), and an accommodating space (13) defined by the two lateral walls (11) and the bottom wall (12) and further having an opening (131) formed at an upper end of the rim body (1); a rim assembly (2) made of a metal material for assembling in the accommodating space (13) of the rim body (1) and having two connecting parts (21) opposite to each other for respectively contacting the two lateral walls (11) of the rim body (1) for positioning, a basal part (22) for connecting lower ends of the two connecting parts (21), and two engaging ribs (23) respectively bending inwardly at upper ends of the two connecting parts (21) and located at the opening (131) at an upper end of the accommodating space (13) of the rim body (1); and a rim coating (3) made of a carbon fiber material for tightly encapsulating on a surface of the rim body (1) assembled with the rim assembly (2).

Accordingly, the molding die of the rim body (1) can serve as a support to sequentially and flatly paste the plural layers of carbon fiber material, which achieves effects of time saving and improving the quality and yield of the rim body (1).

Furthermore, the rim assembly (2) is extruded by the metal material, e.g. aluminum alloy, so the two engaging ribs (23) having engagement function can be formed on the rim assembly (2). When an inner tube and a tire are sequentially assembled to the assembling space (24) of the rim assembly (2), two tire lips at two lateral bottom edges on two sides of the tire are respectively and stably engaged with the two engaging ribs (23) of the rim assembly (2) for positioning and forming a good tightness to effectively prevent the tire falling off from the rim. Additionally, the rim assembly (2) made of the metal material, e.g. aluminum alloy, has high heat dissipation which prevents cracking, puncture and the like due to overheating of the inner tubes and tires.

When the wheel rims of the present invention used in a bicycle are driven to rotate on an uneven road and subjected to shocks, e.g. vibration, the wheel rims can withstand and cushion the impact force transmitted from the tire due to the well ductility of the rim assembly (2) and the rigidity of the rim body (1) and the rim coating (3) so as to prevent themselves from cracking or damage. Since the rim assembly (2) is assembled in the accommodating space (13) for contacting the two lateral walls (11) of the rim body (1) by the two connecting parts (21) and further encapsulated by the rim coating (3), the rim assembly (2) is limited in position by the rim assembly (2) and the rim coating (3) without improper deformation, which improves the safety of the wheel rim. Furthermore, the present invention also achieves effects of lightening the weight of the wheel rim and reducing the manufacturing cost of the wheel rim.

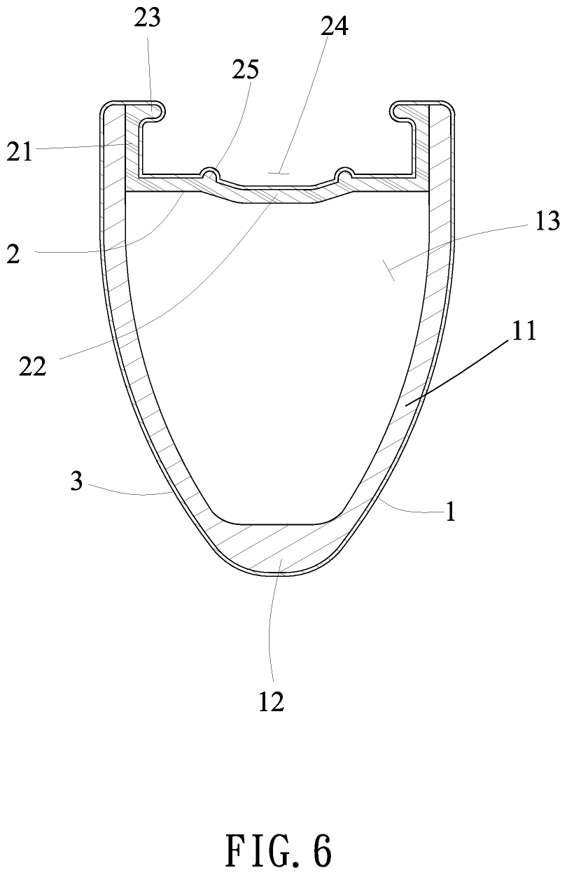

The foregoing embodiments or drawings do not limit the manufacturing method and the structure of the wheel rim of the present invention. For instance, referring to FIG. 6, a schematic diagram showing a second embodiment for a composite wheel in assembly according to the present invention is disclosed. The rim assembly (2) further comprises two flanges (25) integrally formed on the basal part (22) at an interval and spaced apart from the two connecting parts (21). Accordingly, in assembling the tire to the present invention, the laterals of the two tire lips are respectively engaged with the two engaging ribs (23) of the rim assembly (2) for positioning, and the inner sides of the two tire lips are respectively engaged with the two flanges (25) on the basal part (22) for positioning. In such a case, the tire is tightly clamped between the two engaging ribs (23) and the two flanges (25) by the laterals and inner sides of the two tire lips. Therefore, the adhesion of the tire and the rim assembly (2) is increased, and air leakage can be avoided when the wheel rim of the present invention is used as a tubeless wheel rim.

What is claimed is:

1. A manufacturing method of a wheel rim, comprising the steps of:
(a) forming a rim body: preparing a molding die having a cavity and coating plural layers of carbon fiber material in the cavity for hardening and shaping to form the rim body;
(b) forming a rim assembly: extruding a metal material to form the rim assembly having two engaging ribs opposite to each other on an upper end thereof and assembling the rim assembly to the rim body; and
(c) forming a rim coating: tightly encapsulating at least one carbon fiber material on a surface of the rim body assembled with the rim assembly to form the rim coating.

2. The manufacturing method of a wheel rim as claimed in claim 1, wherein the rim body comprises two lateral walls opposite to each other, a bottom wall for connecting lower ends of the two lateral walls, and an accommodating space defined by the two lateral walls and the bottom wall and having an opening formed at an upper end of the rim body, and wherein the rim assembly is correspondingly assembled to the accommodating space of the rim body and comprises two connecting parts opposite to each other for respectively contacting the two lateral walls of the rim body for positioning, a basal part for connecting lower ends of the two connecting parts, and two engaging ribs respectively bending inwardly at upper ends of the two connecting parts and located at the opening at an upper end of the accommodating space.

3. The manufacturing method of a wheel rim as claimed in claim 2, wherein the rim assembly comprising an assembling space defined by the two engaging ribs, the two connecting parts and the basal part and two flanges integrally formed on the basal part at an interval and spaced apart from the two connecting parts.

4. The manufacturing method of a wheel rim as claimed in claim 1, wherein the rim assembly is made of aluminum alloy.

5. The manufacturing method of a wheel rim as claimed in claim 1, wherein the carbon fiber material is a carbon fiber fabric.

6. A structure of a wheel rim, comprising:
a rim body made of a carbon fiber material and having two lateral walls opposite to each other, a bottom wall for connecting lower ends of the two lateral walls, and an accommodating space defined by the two lateral walls and the bottom wall, wherein the accommodating space has an opening formed at an upper end of the rim body;
a rim assembly made of a metal material for assembling in the accommodating space of the rim body and having two connecting parts opposite to each other for respectively contacting the two lateral walls of the rim body for positioning, a basal part for connecting lower ends of the two connecting parts, and two engaging ribs respectively bending inwardly at upper ends of the two connecting parts and located at the opening at an upper end of the accommodating space of the rim body; and
a rim coating made of a carbon fiber material for tightly encapsulating on a surface of the rim body assembled with the rim assembly.

7. The structure of a wheel rim as claimed in claim 6, wherein the rim assembly comprising an assembling space defined by the two engaging ribs, the two connecting parts and the basal part and two flanges integrally formed on the basal part at an interval and spaced apart from the two connecting parts.

8. The structure of a wheel rim as claimed in claim 6, wherein the rim assembly is made of aluminum alloy.

9. The structure of a wheel rim as claimed in claim 6, wherein the carbon fiber material is a carbon fiber fabric.
